(19) United States
(12) Patent Application Publication
(10) Pub. No.: US 2010/0166646 A1
(43) Pub. Date: Jul. 1, 2010

(54) METHOD AND SYSTEM FOR ADJUSTING THE TEMPERATURE PROFILE OF A CATALYZER IN A REFORMER

(75) Inventor: Andreas Lindermeir, Neubrandenburg (DE)

Correspondence Address: DICKINSON WRIGHT PLLC, 1875 Eye Street, NW, Suite 1200, WASHINGTON, DC, 20006, US

(73) Assignee: Enerday GmbH, Stockforf (DE)

(21) Appl. No.: 12/377,443

(22) PCT Filed: Jul. 10, 2007
(86) PCT No.: PCT/DE07/01225

§ 371 Date: Feb. 13, 2009

(30) Foreign Application Priority Data
Aug. 30, 2006 (DE) 10 2006 040 563.3

(51) Int. Cl. C01B 3/26; B01J 19/00

(52) U.S. Cl. 423/651; 422/188

(57) ABSTRACT

The invention relates to a method for adjusting the temperature profile of a catalyst in a reformer.

In accordance with the invention it is provided for that the fuel feed rates in various media feed zones are tweaked so that a wanted temperature profile results in the reforming zone of the reformer whilst maintaining the air ratio as applicable to the overall reforming process.

The invention relates to a method for adjusting the temperature profile of a catalyst in a reformer
wherein the reformer comprises an oxidation zone and a reforming zone featuring the catalyst, the reforming zone being in thermal contact with the oxidation zone,
wherein the reformer comprises first media feed zone and a second media feed zone,
wherein the oxidation zone comprises a first oxidation zone end portion facing the first media feed zone and facing away from the second media feed zone, and a second oxidation zone end portion facing the second media feed zone and facing away from the first media feed zone,
wherein the reforming zone comprises a first reforming zone end portion facing the first media feed zone and facing away from the second media feed zone, and a second reforming zone end portion facing the second media feed zone and facing away from the first media feed zone,

wherein the method comprises the steps
feeding fuel and air to the first media feed zone to generate a fuel/air mixture,
introducing the fuel/air mixture into the oxidation zone via its first oxidation zone end portion and performing a total oxidation reaction with at least a proportion of the fuel supplied to the first media feed zone in the oxidation zone,
feeding fuel to the second media feed zone
combining at least part of the flue gas generated in the oxidation zone and emerging therefrom via the second oxidation zone end portion with the fuel supplied to the second media feed zone to generate a flue gas fuel mixture,
introducing the flue gas fuel mixture into the reforming zone via its second reforming zone end portion and performing a catalytic reforming in the reforming zone,
discharging reformate from the reforming zone via its first reforming zone end portion.

The invention relates furthermore to a system for reforming fuel.

One such method and one such system are known from German patent DE 103 59 205 A1 employed in the scope of fuel cell systems operated with hydrocarbons such as natural gas, gasoline or diesel. The reformer generates from the supply of hydrocarbon and air a mixture which is reacted in the reformer into a hydrogen rich reformate. This reformate is supplied to the anode end of a fuel cell respectively a fuel cell stack. In catalytic reforming of the fuel/air mixture a temperature profile materializes within the catalyst through which the reacting gases stream. This temperature profile generally has a much higher level at the catalyst inlet than at the catalyst outlet. The reason for this is that at the catalyst inlet the oxidation reactions taking place are strongly exothermic whilst the actual endothermic reforming takes place in the downstream catalyst portion, water gas shift reactions occurring in the transition portion. The drop in temperature existing in the direction of flow in the catalyst results in a loss of output of the reformer as well as in problems due to the temperatures materializing as a maximum; whilst in the downstream portion of the catalyst, i.e. where the endothermic reforming reactions take place, temperatures of below 700° C. exist, temperatures exceeding 1000° C. occur in the upstream portion where the oxidation reactions play a major role, which may result in the catalyst becoming thermally overloaded.

These problems were solved in part by the achievement of German patent DE 103 59 205 A1. By engineering a two-stage fuel feeder the temperature profile in the catalyst can be homogenized but without the possibility of adjusting the temperature profile as required.

The invention is based on the object of sophisticating the generic methods and systems such that adjusting the temperature profile as required is now possible in the catalyst respectively in the reforming zone of a two-stage reformer.

This object is achieved by the features of the independent claim.

Advantageous embodiments of the invention read from the dependent claims.

The invention is a sophistication over the generic method in that the feed rates of the air and fuel supplied to the first media feed zone as well as the feed rates of the fuel supplied to the second media feed zone are adapted to each other so that the temperature profile of the catalyst is now as wanted, an air ratio relative to the process overall now assuming or maintaining a predefined value. Now, by the existence of two media feed zones via both of which fuel and via at least one of which air can be supplied, the corresponding feed rates can be adjusted so that although the air ratio (λ) relating to the process overall assumes a predefined value or remains at a predefined value, the individual feed rates in the media feed zones can be varied each as a function of the other. It is in this way that the temperature conditions in the system vary in thus enabling the temperature profile of the catalyst to assume a wanted profile.

It is particularly provided for that the wanted temperature profile remains constant, this being a special instance of a wanted profile. But it may just as well be desired that a temperature exists in the first reforming zone end portion which is slightly higher than in the second reforming zone end portion, it being just as possible that the reverse is wanted as regards the temperature conditions. But in any case it is wanted that the differences in temperature over the catalyst are diminished.

In accordance with a preferred embodiment of the present invention it is provided for that the temperature profile is sensed. By sensing the temperature profile during reformer operation it can be established whether the profile is as wanted or at least acceptable; if not, the feed rates into the media feed zones are tweaked until the temperature profile is acceptable, in other words, in particular constant.

It may be likewise provided for that the temperature profile is known as a function of the reformer output as well as of the fuel and air feed rates, these functions being taken into account when adapting the fuel and air feed rates. This function of the temperature profile as regards the reformer output and of the media feed rates can be memorized in the form of a truth table in an electronic controller so that when the reformer is operated with a certain output it is evident from the truth table how the feed rates in the individual media feed zones are to be selected for a development of the temperature profile in the direction of that as wanted. This method as based on a truth table can be employed in parallel to the method based on sensing the temperature profile or even as a replacement therefore.

In accordance with a preferred embodiment of the method in accordance with the invention it is provided for that when the reformer output is constant the air feed is substantially constant. This is why the parameters influencing the air ratios in the two media feed zones are exclusively the fuel feed rates as are basically adequate for achieving the method in accordance with the invention. In this arrangement, especially with a constant air feed in the first media feed zone it may be sufficient to introduce fuel only in the second media feed zone.

However, it may also be provided for that air is supplied to the second media feed zone.

In accordance with a particularly preferred embodiment of the method in accordance with the invention it is provided for that when the temperature profile is characterized by temperatures which are too low in the second reforming zone end portion and too high in the first reforming zone end portion, the feed rate of the fuel supplied to the first media feed zone is reduced whilst the feed rate of the fuel supplied to the second media feed zone is increased, the air feed rate being maintained constant. Reducing the fuel feed rate to the first media feed zone increases the air ratio, resulting in a reduction of the flue gas temperature. As a result of this, the first reforming zone end portion is supplied with a diminished flow of heat, resulting in a drop in its temperature. Increasing the fuel feed rate in the second media feed zone maintains the air ratio of the process overall constant.

It is correspondingly provided for that when the temperature profile is characterized by temperatures which are too high in the second reforming zone end portion and too low in the first reforming zone end portion the feed rate of the fuel supplied to the first media feed zone is increased whilst the feed rate of the fuel supplied to the second media feed zone is reduced, the air feed rate being maintained constant.

The invention relates furthermore to a system for reforming fuel including a reformer and an electronic controller, the latter being suitable for open or closed loop control of a method in accordance with any of the preceding claims.

The invention is based on having discovered that although the system can be operated with a constant air ratio by influencing the media feed of several media feed zones, the temperature profile in the catalyst can still be adjusted as required. To support adjusting the temperature profile as required, it can be additionally provided for that the heat transfer between the oxidation portion and the reforming zone can be adapted by engineering, e.g. modifying the heat exchanger surface or the coefficient of thermal conductivity, namely especially in enhancing the heat transfer at the output end of the reforming zone and for a reduced heat transfer at the input end of the reforming zone.

The invention will now be detailed by way of preferred embodiments with reference to the attached drawings in which:

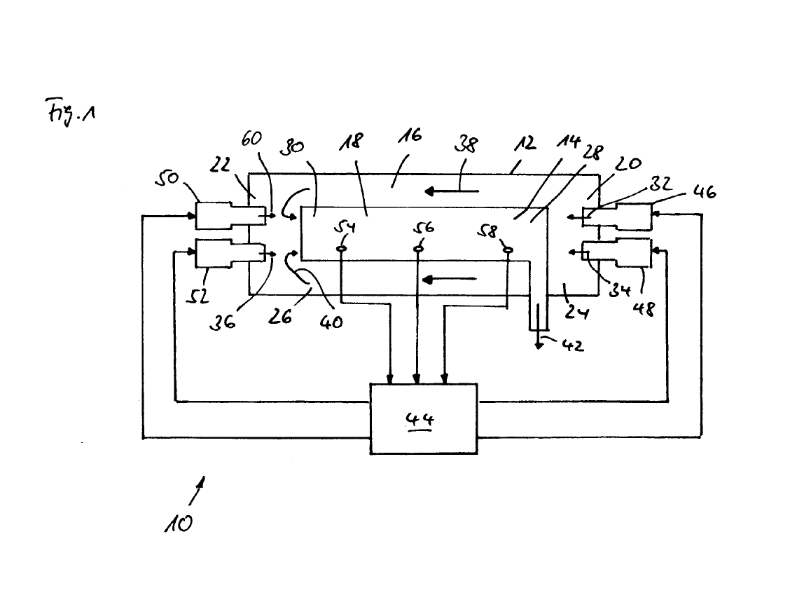

FIG. 1 is a diagrammatic representation of a first embodiment of a system in accordance with the invention;

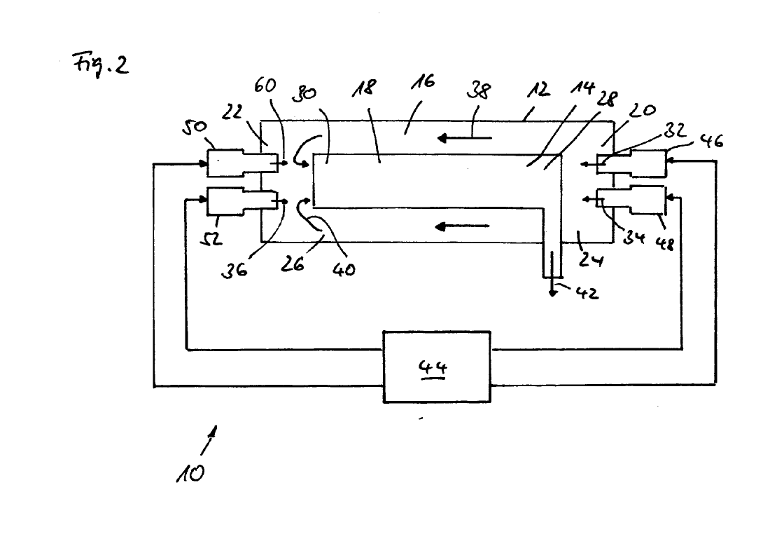

FIG. 2 is a diagrammatic representation of a second embodiment of a system in accordance with the invention;

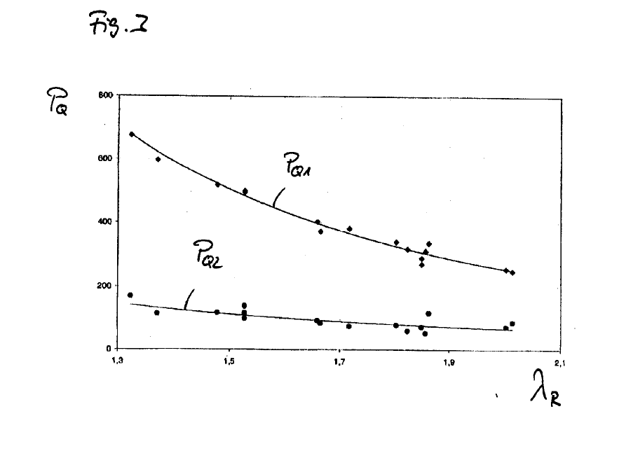

FIG. 3 is a graph explaining the invention, and

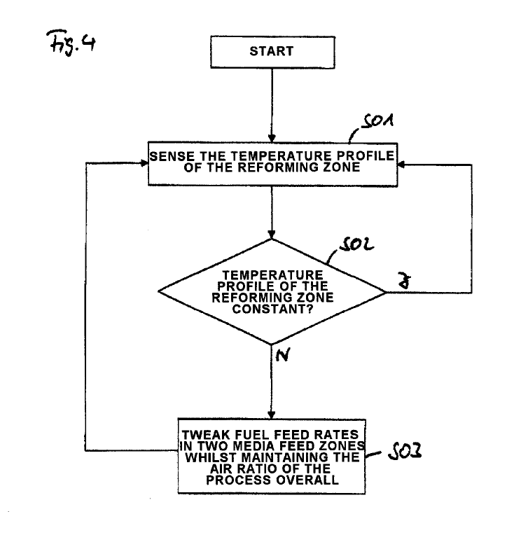

FIG. 4 is a flow chart explaining a method in accordance with the invention.

In the following description of the drawings like reference numerals identify like or comparable components.

Referring now to FIG. 1 there is illustrated a diagrammatic representation of a first embodiment of a system in accordance with the invention. The system 10 comprises a reformer 12 and a electronic controller 44. The reformer 12 is engineered substantially tubular with two arranged substantially concentrical zones, namely an oxidation zone 16 and a reforming zone 18, the reforming zone 18 including a catalyst 14. The reformer 12 has a first media feed zone 20 including a fuel feeder 46, by means of which fuel 32 can be introduced into the first media feed zone 20. Air 34 also can be introduced into the first media feed zone 20 by means of an air feeder 48. The reformer 12 features in addition a second media feed zone 22 into which likewise fuel 60 can be fed via a further fuel feeder 50. Optionally a further air feeder 52 can be provided via which air 36 can be introduced into the second media feed zone 22. Sited in the reforming zone 18 and catalyst 14 respectively are temperature sensors 54, 56, 58 for sensing the temperature of the catalyst 14 and reforming zone 18 respectively at various locations to thus communicate the temperature profile of the catalyst 14 and reforming zone 18 respectively to the electronic controller 44 which likewise tweaks the fuel and air feed rates, namely by signalling adjustment of means of dispensing the fuel, for example, pumps and blowers.

The system in accordance with the invention works as follows: fuel 32 is supplied to the first media feed zone 20 by the fuel feeder 46, the fuel feed rate being dictated by the electronic controller 44. Likewise, air 34 is supplied to the first media feed zone 20, the flow rate of which is also determined by the electronic controller 44. Fuel 32 and air 34 intermingle and enter the oxidation zone 16 via the oxidation zone end portion 24 where an exothermic reaction takes place, resulting in flue gas 38.

This flue gas leaves the oxidation zone 16 via the second oxidation zone end portion 26 and then attains the second media feed zone 22 into which at least fuel 60 is fed via the fuel feeder 50, the feed rate of which is in turn dictated by the electronic controller 44. When an air feeder 52 is provided at the second media feed zone 22 additional air 36 can be supplied, the feed rate of which is likewise established by the electronic controller 44. In the following description it is assumed that the second media feed zone 22 has no air feeder. The flue gas fuel mixture materializing in the second media feed zone 22 is supplied to the reforming zone 18 and thus to the catalyst 14 where firstly further exothermic reactions take place in the reforming zone end portion 30. Further streaming through the reforming zone 18 results in water gas shift reactions after which reforming occurs proper and the final reformate 42 can be tapped from the reformer 12.

When a temperature profile is established by the temperature sensors 54, 56, 58—here three in number merely as an example—characterized by the temperatures in the second reforming zone end portion being too high and too low in the first reforming zone end portion, with the air feed rate constant in the first media feed zone 20 the fuel feed rate is reduced whilst in the second media feed zone 22 the fuel feed rate 50 is increased. In this way the air ratio as regards the overall process remains constant whilst the air ratio of the flue gas 38 increases. This results in less heat being transmitted to the first reforming zone end portion 28, changing the temperature profile in the reforming zone. When the temperatures in the second reforming zone end portion are too high and too low in the first reforming zone end portion the mixture supplied to the oxidation zone 16 is tweaked with a lower air ratio, resulting in more heat being communicated to the first reforming zone end portion 28 so that in this case too, the temperature profile can be adapted as wanted.

Referring now to FIG. 2 there is illustrated a diagrammatic representation of a second embodiment of a system in accordance with the invention. This embodiment corresponding to that as shown in FIG. 1 except that no temperature sensors are provided to signal the electronic controller 44. Tweaking the fuel feed rates in the individual media feed zones 20, 22 in accordance with the invention is nevertheless provided for, namely on the basis of a truth table memorized in the electronic controller 44 itself. In knowledge of the temperature profile as a function of the output and the individual media feed rates the latter can be tweaked so that a wanted temperature profile is obtained, namely by taken into account the information memorized in the form of the truth table.

Referring now to FIG. 3 there is illustrated a graph explaining the invention, showing the output P_{Q} of the oxidation zone 16 as a function of the air ratio of the reacting mixture λ_{R} in the ambience of the first reforming zone end portion 28, separately plotting the heat P_{Q1} given off to the ambience and heat P_{Q2} given off to the reforming zone 18 and catalyst 14 respectively. It is evident that although the heat P_{Q1} given off to the ambient increases when the air ratio λ_{R} is reduced, i.e. in making available a richer mixture, the heat P_{Q2} given off to the reforming zone 18 is also increased. In other words, reducing the air ratio permits increasing the heat given off to the first reforming zone end portion 28; conversely, increasing the air ratio λ_{R} results in the heat communicated to the first reforming zone end portion 28 being reduced. In all, therefore, this permits adapting the temperature profile whilst maintaining the air ratio as relevant to the overall process. In this arrangement the heat P_{Q1} given off to the ambience can be reduced by suitable means, e.g. thermal insulation.

Referring now to FIG. 4 there is illustrated a flow chart explaining a method in accordance with the invention. After starting the method in accordance with the invention, in SO1 the temperature profile in the reforming zone is obtained, namely with the aid of temperature sensors and/or by way of a memorized truth table. In S02 it is then checked whether the temperature profile of the reforming zone corresponds substantially to the profile as wanted. If so, then there is no need for an improvement and the method continues with the temperature as sensed in S01. But if the temperature profile in the reforming zone is not as it should be, then in S03 the fuel feed rates in the media feed zones are tweaked whilst maintaining the air ratio of the overall process constant, i.e. to thus optimize the temperature profile. After this, the method is continued by obtaining the temperature profile again in S01.

The electronic controller 44 as mentioned relevant to the present invention may be dedicated to the reforming process. It is expedient however when this controller also handles the remaining functions in controlling the overall fuel cell system at least in part.

It is understood that the features of the invention as disclosed in the above description, in the drawings and as claimed may be essential to achieving the invention both by themselves or in any combination.

### LIST OF REFERENCE NUMERALS

10 fuel cell system

12 reformer

14 catalyst

16 oxidation zone

18 reforming zone

20 first media feed zone

22 second media feed zone

24 first oxidation zone end portion

26 second oxidation zone end portion

28 first reforming zone end portion

30 second reforming zone end portion

32 fuel

34 air

36 air

38 flue gas/fuel air mixture

42 reformate

44 electronic controller

46 fuel feeder

48 air feeder

50 fuel feeder

52 air feeder

54 temperature sensor

56 temperature sensor

58 temperature sensor

60 fuel

1. A method for adjusting the temperature profile of a catalyst in a reformer
wherein the reformer comprises an oxidation zone and a reforming zone featuring the catalyst, the reforming zone being in thermal contact with the oxidation zone,
wherein the reformer comprises a first media feed zone and a second media feed zone,
wherein the oxidation zone comprises a first oxidation zone end portion facing the first media feed zone and facing away from the second media feed zone, and a second oxidation zone end portion facing the second media feed zone and facing away from the first media feed zone,
wherein the reforming zone comprises a first reforming zone end portion facing the first media feed zone and facing away from the second media feed zone, and a second reforming zone end portion facing the second media feed zone and facing away from the first media feed zone,
wherein the method comprises the steps of:
feeding fuel and air to the first media feed zone to generate a fuel/air mixture,
introducing the fuel/air mixture into the oxidation zone via its first oxidation zone end portion and performing a total oxidation reaction with at least a proportion of the fuel supplied to the first media feed zone in the oxidation zone,
feeding fuel to the second media feed zone,
combining at least part of the flue gas generated in the oxidation zone and emerging therefrom via the second oxidation zone end portion with the fuel supplied to the second media feed zone to generate a flue gas fuel mixture,
introducing the flue gas fuel mixture into the reforming zone via its second reforming zone end portion and performing a catalytic reforming in the reforming zone, and
discharging reformate from the reforming zone via its first reforming zone end portion,
characterized in that the feed rates of the air and fuel supplied to the first media feed zone (20) as well as the feed rates of the fuel supplied to the second media feed zone are adapted to each other so that the temperature profile of the catalyst is as wanted, an air ratio relative to the process overall assuming or maintaining a predefined value.

2. The method of claim 1, wherein the wanted temperature profile remains constant.

3. The method of claim 1, wherein the temperature profile is sensed.

4. The method of claim 1, wherein the temperature profile is known as a function of the reformer output as well as of the fuel and air feed rates, these functions being taken into account when tweaking the fuel and air feed rates.

5. The method of claim 1, wherein when the reformer output is constant the air feed is substantially constant.

6. The method of claim 1, wherein air is supplied to the second media feed zone.

7. The method of claim 1, wherein when the temperature profile is characterized by temperatures which are too low in the second reforming zone end portion and too high in the first reforming zone end portion the feed rate of the fuel supplied to the first media feed zone is reduced whilst the feed rate of the fuel supplied to the second media feed zone is increased, the air feed rate being maintained constant.

8. The method of claim 1, wherein when the temperature profile is characterized by temperatures which are too high in the second reforming zone end portion and too low in the first reforming zone end portion the feed rate of the fuel supplied to the first media feed zone is increased whilst the feed rate of the fuel supplied to the second media feed zone is reduced, the air feed rate being maintained constant.

9. A system for reforming fuel including a reformer and an electronic controller, the controller being suitable for open or closed loop control of a method in accordance with claim 1.
